(19) United States
(12) Patent Application Publication
(10) Pub. No.: US 2010/0172224 A1
(43) Pub. Date: Jul. 8, 2010

(54) APPARATUS AND METHOD FOR CONTROLLING CURRENT OF DATA LINE

(76) Inventor: Jumyong CHO, Seoul (KR)

Correspondence Address: BIRCH STEWART KOLASCH & BIRCH, PO BOX 747, FALLS CHURCH, VA, 22040-0747, US

(21) Appl. No.: 12/652,601

(22) Filed: Jan. 5, 2010

(30) Foreign Application Priority Data
Jan. 6, 2009 (KR) 10-2009-0000606
Jan. 6, 2009 (KR) 10-2009-0000609

(51) Int. Cl. G11B 7/00

(52) U.S. Cl. 369/47.5; G9B/7

(57) ABSTRACT

This document relates to a method and apparatus for controlling the current of a data line. The method may comprise determining a type of an optical disc inserted into the ODD, and differently controlling the current of the data line, coupled to a host, according to the determined type. If the optical disc is determined to be a disc of a video title, current to be applied to a level rising transition of the signal may be decreased, and if the optical disc is determined to be an audio disc or a data disc, the current of the data line may maintain a preset reference value. Accordingly, EMI occurring when a video title is played in the ODD can be minimized more efficiently.

This application claims the benefit of Korean Patent Applications No. 10-2009-0000606 and 10-2009-0000609 filed on Jan. 6, 2009, which are hereby incorporated by reference.

### BACKGROUND

1. Field

This document relates to a method of controlling the current of a data line when the data line is connected to a host.

2. Related Art

In general, Electro Magnetic Interference (EMI) also widely known as electromagnetic disturbance refers to that electromagnetic waves directly radiated or conducted from an electronic or electrical equipment influence other electronic or electrical equipment, thereby disturbing the function of receiving an electromagnetic signal.

For example, the International Electrotechnical Commission (IEC) defines that EMI causes disturbance in receiving a desired electromagnetic signal through an unnecessary electromagnetic signal or electromagnetic noise.

Meanwhile, EMI beginning to make its appearance from the 1930's was chiefly handled in the range of EMI until the 1950's. Group Radio Frequency Interference (GRFI) (i.e., an expert group which handles directly radiated EMI from an electronic or electrical equipment and conductive EMI from a power line) was established within the Institute of Electrical and Electronics Engineers (IEEE) in the year of 1958.

With a sudden increase in the use of various electronic devices and with the development of digital technology and semiconductor technology, the application fields of precision electronic devices are being diversified, and so electromagnetic disturbances generated from the devices cause EMI, the malfunction of the devices, and biological hazards to organisms, including the human body. Accordingly, the influence of electromagnetic disturbances on the electronic energy of an ecosystem is emerging as a significant problem.

Further, technical committees (TC-77) that handle Electro Magnetic Compatibility (EMC) (i.e., electronic environmental problems) were established in the 1973's and are deliberating on the electronic environmental problems.

In particular, the influence of electromagnetic waves on an organism is serious. A thermal effect influencing an organism is the result of electronic energy absorbed by the organism and gives rises to a temperature rise, which may damage the tissues and functions of the organism. Accordingly, electronic system levels that are recognized as being safe for the human body are set in WHO, IRPA, or various countries, such as U.S. (ANSI, NIOSH, and ACGIH), Canada, Russia, and Germany.

In general, an Optical Disc Drive (ODD) configured to record data on an optical disc, such as CD or DVD, or to play data recorded thereon can be connected to a host, such as a Personal Computer (PC).

In the case in which in the above ODD, audio and video data played from the optical disc are transmitted to the host, the ODD and the host perform an operation for checking communication errors (for example, Cyclic Redundancy Checking (CRC)).

The CRC operation is performed in order to check whether errors exist in data which are transmitted and received via a data line. The ODD applies a 16-bit polynomial expression or a 32-bit polynomial expression to data blocks to be transmitted and transmits codes, obtained as a result of the application, with the codes added to the data blocks.

The host applies the same polynomial expression to the data blocks and compares codes, obtained as a result of the application, with the codes of the data blocks received from the ODD. If, as a result of the comparison, the two codes are identical with each other, the host determines that the data blocks have been successfully transmitted and received. However, if, as a result of the comparison, the two codes are not identical with each other, the host requests the ODD to retransmit the data blocks.

However, if excessive under-shoot or over-shoot is generated in the level transitions of a signal of the data line between the ODD and the host, errors may occur in the CRC operation.

### SUMMARY

An aspect of this document is to provide a method and apparatus for more efficiently reducing EMI occurring when data are transmitted and received via an interface (for example, Advanced Technology Attachment Packet Interface (ATAPI)) between a host and an ODD.

Another aspect of this document is to provide a method and apparatus for preventing over-shoot or under-shoot occurring when the level of a signal transmitted and received through the data line of an interface (for example, an ATAPI) is shifted.

In an aspect of this document, a method of controlling current of the data line in an ODD comprises determining a type of an optical disc inserted into the ODD and differently controlling the current of the data line, coupled to a host, according to the determined type.

In another aspect of this document, an ODD comprises an interface unit for connection to a host, a power supply unit configured to control current of a data line coupled to the host, and a control unit configured to determine a type of an optical disc inserted into the ODD and control the power supply unit according to the determined type such that the current of the data line is differently controlled.

In an embodiment, if, as a result of the determination, the optical disc is determined to be a disc of a video title, the current of the data line may be decreased. Current to be applied to a level falling transition of a signal transmitted via the data line may remain intact, and current to be applied to a level rising transition of the signal may be decreased.

In an embodiment, if, as a result of the determination, the optical disc is determined to be an audio disc or a data disc, the current of the data line may maintain a preset reference value.

In yet another aspect of this document, a method of controlling current of the data line comprises detecting a pulse cycle and a level transition time in a signal transmitted via a data line coupled to a host, comparing a reference value and a first value obtained by dividing the level transition time by the pulse cycle, and maintaining or controlling the current of the data line according to a result of the comparison.

In further yet another aspect of this document, an apparatus for controlling current of a data line comprises an interface unit for connection to a host, a detection unit configured to detect a pulse cycle and a level transition time in a signal transmitted via the data line coupled to the host, a power supply unit configured to control the current of the data line, and a control unit configured to compare a reference value and a first value obtained by dividing the level transition time by the pulse cycle and control the power supply unit to maintain or adjust the current of the data line according to a result of the comparison.

In an embodiment, if, as a result of the comparison, the first value falls within the reference value, current to be applied to a level falling transition and a level rising transition of the signal may be maintained at a preset value.

In an embodiment, if, as a result of the comparison, the first value exceeds the reference value, current to be applied to a level falling transition of the signal may be maintained at a preset value, and current to be applied to a level rising transition of the signal may be increased.

In an embodiment, if, as a result of the comparison, the first value is less than the reference value, current to be applied to a level falling transition of the signal may be maintained at a preset value, and current to be applied to a level rising transition of the signal may be decreased.

In the embodiments, the data line may comprise an ATAPI data line.

### BRIEF DESCRIPTION OF THE DRAWINGS

The accompany drawings, which are included to provide a further understanding of this document and are incorporated on and constitute a part of this specification illustrate embodiments of this document and together with the description serve to explain the principles of this document.

FIG. 1 is a block diagram of an ODD according to this document;

FIG. 2 is a flowchart illustrating a method of controlling current of the data line in the ODD according to an embodiment of this document;

FIG. 3 is a diagram showing a list of EMI test results according to an embodiment of this document;

FIG. 4 is a flowchart illustrating a method of controlling current of the data line according to another embodiment of this document; and

FIGS. 5 to 7 are diagrams showing the results of detecting data line pulses and a process of controlling current according to another embodiment of this document.

### DETAILED DESCRIPTION

Some embodiments of an ODD and a method of controlling current of a data line are described in detail with reference to the attached drawings.

This document can be applied to an apparatus (for example, an ODD) connected to a host, such as a personal computer, via an interface (for example, an ATAPI).

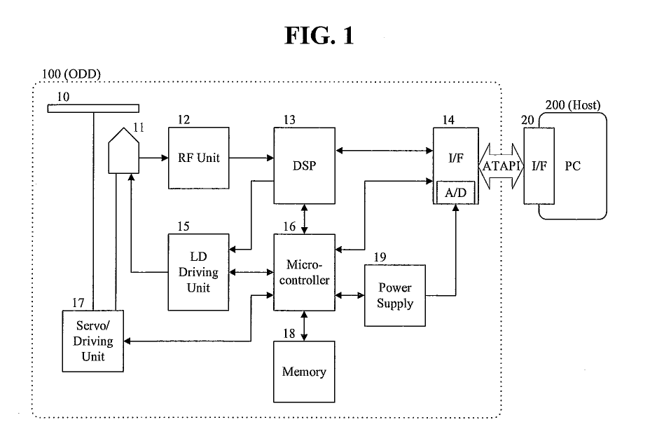

The ODD to which this document is applied, as shown in FIG. 1, may comprise an optical pickup 11, an RF unit 12, a Digital Signal Processor (DSP) 13, an interface (I/F) unit 14, a Laser Diode (LD) driving unit 15, a microcontroller 16, a servo/driving unit 17, memory 18, and a power supply unit 19.

The microcontroller 16 is configured to determine the type of an optical disc 10 inserted into the ODD and to control the servo/driving unit 17, the LD driving unit 15, the digital signal processor 13, and the like at the request of a user so that data recorded on the optical disc 10 are read and played and played data are outputted to a host 200, such as a personal computer, which is connected thereto via the interface unit 14.

The microcontroller 16 is configured to control the power supply unit 19 such that the current value of an ATAPI data line for transmission and reception of data to and from, for example, the host 200 is controlled. The microcontroller 16 can differently control current supplied to the two terminals included in the interface unit 14 by varying the current supplied to the two terminals. Here, one of the two terminals is used to control the falling transition of a signal transmitted via the data line, and the other of the two terminals is used to control the rising transition of the signal.

For example, the basic current value of the data line is set to 8 mA in accordance with the Automatic Program Control (APC) Specification 1 and APC Specification 2. The APC Specification 1 defines the amount of current which will be applied to the falling transition of a signal transmitted via a data line, and the APC Specification 2 defines the amount of current which will be applied to the rising transition of a signal transmitted via a data line.

In an embodiment of this document, the amount of current supplied to the ATAPI data line can be differently controlled according to the type of an optical disc inserted into the ODD. For example, in the disc of a video title which is expected to have a lot of EMI because of a large amount of transmission data, the amount of current supplied to the ATAPI data line can be reduced.

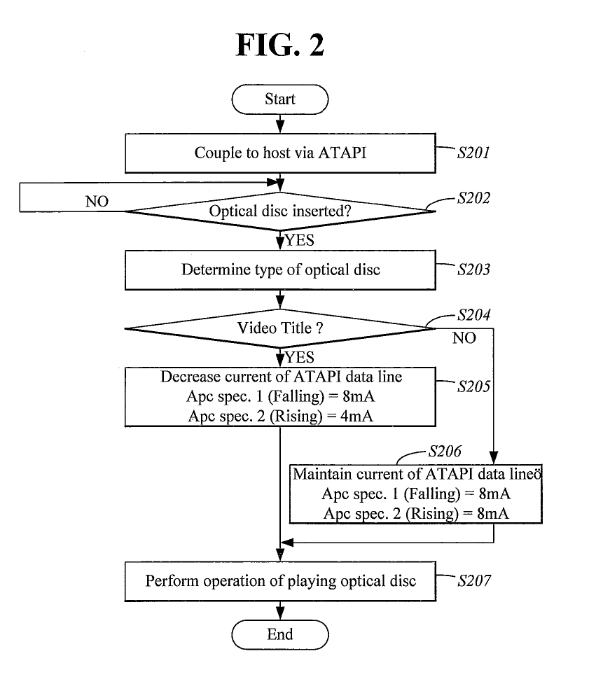

FIG. 2 is a flowchart illustrating a method of controlling current of the data line in the ODD according to an embodiment of this document.

The ODD 100 is first coupled to the host 200 via the ATAPI data line at step S201. In this state, if the optical disc 10, such as a CD or a DVD, is determined to be inserted into the ODD at step S202, the microcontroller 16 determines the type of the optical disc at step S203 and determines whether the optical disc is a video title at step S204.

For example, in the case in which data recorded in the data area of the optical disc are video data as a result of reading navigation information recorded in the lead-in area of the optical disc at step S204 (YES), the microcontroller 16 expects that a lot of EMI will be generated because of the transmission of the video data and controls the current value of the ATAPI data line of the interface unit 14 such that the current value is lower than a preset current value at step S205.

For example, the microcontroller 16 can set the value of the APC Specification 1, defining the current for the falling transition, to 8 mA and the value of the APC Specification 2, defining the current for the rising transition, to 4 mA, and control the power supply unit 19 based on the set values such that 8 mA (APC specification 1) is applied to one terminal of the interface unit 14, which is pertinent to the falling transition of the ATAPI data line, and 4 mA (APC specification 2) is applied to the other terminal of the interface unit 14, which is pertinent to the rising transition of the ATAPI data line.

However, if, as a result of the determination at step S204, the type of the optical disc is determined to be an audio (for example, music) or data (for example, text) optical disc not the video title, the microcontroller 16 expects that a small amount of EMI will be generated and maintains the current value of the ATAPI data line of the interface unit 14 to a preset basic current value at step S206.

For example, the microcontroller 16 can maintain the value of the APC Specification 1 for the falling transition to 8 mA and the value of the APC Specification 2 for the rising transition to 8 mA and control the power supply unit 19 such that 8 mA is applied to one terminal of the interface unit 14, which is pertinent to the falling transition of the ATAPI data line, and 8 mA is applied to the other terminal of the interface unit 14, which is pertinent to the rising transition of the ATAPI data line.

Next, in the state in which the current values of the ATAPI data line are set to 8 mA, the microcontroller 16 performs a play operation of transmitting audio or data, played from the optical disc, to the host, or in the state in which the current values of the ATAPI data line are differently set to 8 mA and 4 mA, the microcontroller 16 performs a play operation of transmitting video, played from the optical disc, to the host at step S207.

Accordingly, EMI generated in the process of transmitting video data, played from the ODD, to the host can be reduced more efficiently.

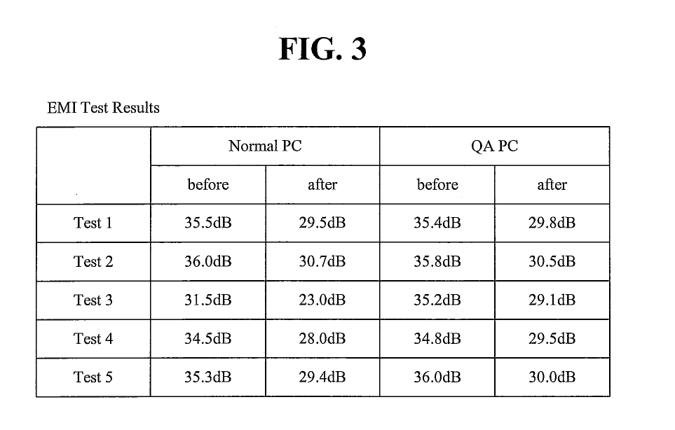

For example, from FIG. 3 showing the results of measuring EMI generated in the ODD coupled to a normal PC and a QA PC before and after this document is applied, it can be seen that EMI is very low after this document is applied.

Meanwhile, in another embodiment of this document, the amount of current supplied to the data line can be controlled based on the level transition time of a signal in order to prevent errors from occurring due to over-shoot or under-shoot when the level of the signal is shifted in the data line coupled to the host.

An analog/digital (A/D) converter included in the interface unit 14 or the digital signal processor 13 (alternatively, the A/D converter may be configured separately from the interface unit 14 or the digital signal processor 13) converts an analog signal of the ATAPI data line, coupled to the host, into a digital signal.

The microcontroller 16 or the digital signal processor 13 receives the digital signal and detects the pulse cycle T (for example, 60 ns) and the level transition time ‘t’ (for example, a transition time from a low level to a high level (the time of a rising period) or a transition time from a high level to a low level (the time of a falling period) of the signal which is transmitted and received via the ATAPI data line.

The microcontroller 16 determines whether a value (t/T) obtained by dividing the level transition time ‘t’ by the pulse cycle ‘T’ falls within a preset range of a reference value (for example, (4.75 ns to 5.25 ns)/60 ns) and controls the power supply unit 19 based on a result of the determination such that the current value of the ATAPI data line remains intact or the current value thereof is increased or decreased as much as a preset amount. Accordingly, excessive under-shoot or over-shoot can be prevented from occurring in the signal of the ATAPI data line, which is transmitted to the host.

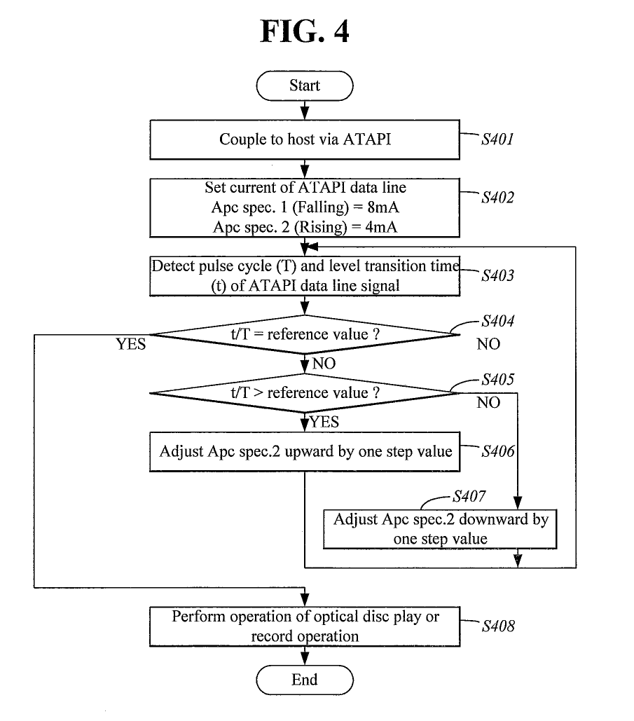

FIG. 4 is a flowchart illustrating a method of controlling current of the data line of the ODD according to another embodiment of this document.

For example, as described above with reference to FIG. 1, in the state in which the ODD 100 and the host 200 are connected each other via the ATAPI interface at step S401, when a system booting operation is performed, the microcontroller 16 controls the power supply unit 19 so that a preset reference current value is applied to the ATAPI data line of the interface unit 14 at step S402. For example, the value of the APC Specification 1 for the falling transition of the ATAPI data line may be set to 8 mA, and the value of the APC Specification 2 for the rising transition of the ATAPI data line may be set to 8 mA, and the set values 8 mA and 8 mA can be supplied to one terminal pertinent to the falling transition and the other terminal pertinent to the rising transition, respectively.

Next, the microcontroller 16 detects the pulse cycle T and the level transition time ‘t’ from the signal of the ATAPI data line, which is converted from an analog signal into a digital signal by the A/D converter included in the digital signal processor 13 or the interface unit 14, at step S403.

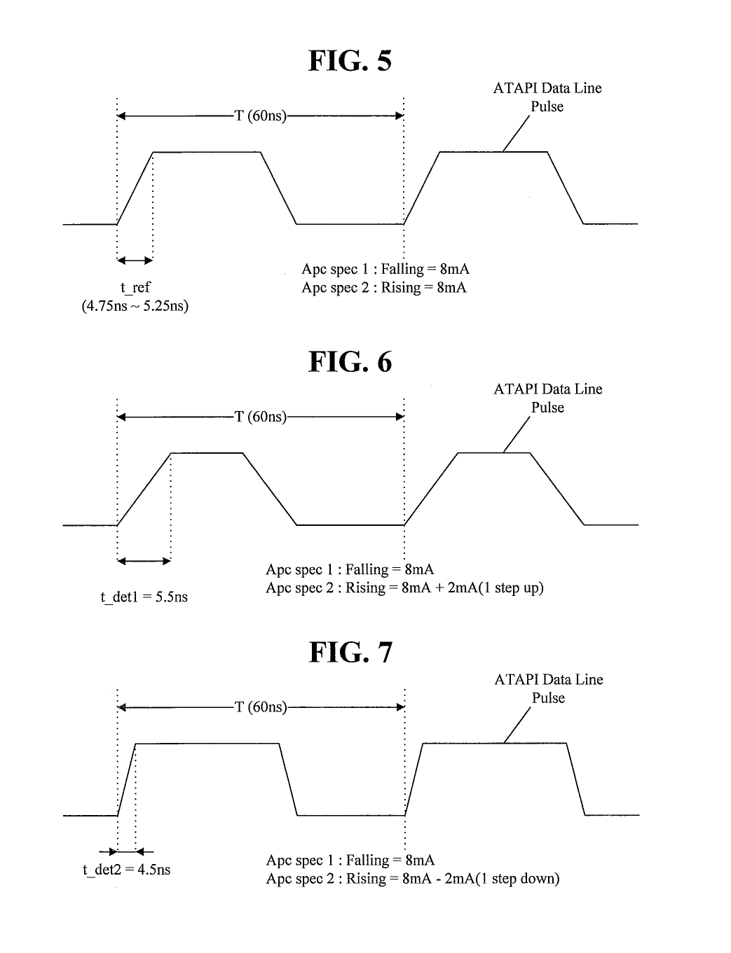

For example, referring to FIG. 5, in the state in which 8 mA (i.e., the preset reference current value) is supplied to each of one terminal pertinent to the falling transition of the ATAPI data line and the other terminal pertinent to the rising transition of the ATAPI data line, the pulse cycle (T=60 ns) and the level transition time ‘t’ of the signal which is transmitted and received via the ATAPI data line are detected.

Next, the microcontroller 16 determines whether a value (t/T) obtained by dividing the level transition time by the pulse cycle falls within a present range of a reference value (for example, (4.75 ns to 5.25 ns)/60 ns) at step S404. If, as a result of the determination at step S404, the value (t/T) is determined to fall within the present range of a reference value (YES), the microcontroller 16 continues to supply the preset reference current value of 8 mA to each of one terminal pertinent to the falling transition of the ATAPI data line and the other terminal pertinent to the rising transition of the ATAPI data line.

However, if, as a result of the determination at step S404, the value (t/T) is determined not to fall within the present range of a reference value (NO), the microcontroller 16 determines whether the value (t/T) exceeds the preset range of a reference value at step S405. As shown in FIG. 6, if the value (t/T) (for example, 5.5 ns/60 ns) in which the level transition time ‘t’ is divided by the pulse cycle T exceeds the preset reference value (YES at step S405), the preset reference current value of 8 mA continues to be supplied to one terminal pertinent to the falling transition of the ATAPI data line, but the current value supplied to the other terminal pertinent to the rising transition of the ATAPI data line is raised. For example, a current value which is one step (for example, 1 step=2 mA) higher than the preset reference current value of 8 mA can be supplied to the other terminal at step S406.

If, as a result of the determination at step S405, the value (t/T) (for example, 4.5 ns/60 ns) is less than the preset reference value (NO), as shown in FIG. 7, the microcontroller 16 controls the power supply unit 19 such that the preset reference current value of 8 mA continues to be supplied to one terminal pertinent to the falling transition of the ATAPI data line, but the current value supplied to the other terminal pertinent to the rising transition of the ATAPI data line is decreased. For example, a current value which is one step (for example, 1 step=2 mA) lower than the preset reference current value of 8 mA can be supplied to the other terminal at step S407.

Next, when the value (t/T) becomes the preset range of a reference value (for example, (4.75 ns to 5.25 ns)/60 ns) through the detection and control operations, the microcontroller 16 performs a play operation of playing data recorded on the optical disc and transmitting the played data to the host or a record operation of receiving data from the host and recording the received data on the optical disc at step S408.

Accordingly, when the level of a signal transmitted to the host via the ATAPI data line is shifted, the occurrence of under-shoot or over-shoot can be prevented, and so errors occurring in a process of transmitting and receiving data can be efficiently prevented.

Further, EMI occurring when a video title is played in the ODD can be minimized more efficiently.

In addition, error occurring during a CRC operation in a process of transmitting and receiving data to and from the host can be efficiently prevented.

While this document has been described in connection with what is presently considered to be practical exemplary embodiments, it is to be understood that this document is not limited to the disclosed embodiments, but, on the contrary, is intended to cover various modifications, changes, substitutions, additions, and equivalent arrangements included within the spirit and scope of the appended claims.

What is claimed is:

1. A method of controlling current of a data line in an Optical Disc Drive (ODD), the method comprising:
determining a type of an optical disc inserted into the ODD; and
differently controlling the current of the data line, coupled to a host, according to the determined type.

2. The method of claim 1, wherein if, as a result of the determination, the optical disc is determined to be a disc of a video title, the current of the data line is decreased.

3. The method of claim 2, wherein:
current to be applied to a level falling transition of a signal transmitted via the data line remains intact, and
current to be applied to a level rising transition of the signal is decreased.

4. The method of claim 1, wherein if, as a result of the determination, the optical disc is determined to be an audio disc or a data disc, the current of the data line maintains a preset reference value.

5. The method of claim 1, wherein the data line comprises an Advanced Technology Attachment Packet Interface (ATAPI) data line.

6. An ODD, comprising:
an interface unit for connection to a host;
a power supply unit configured to control current of a data line coupled to the host; and
a control unit configured to determine a type of an optical disc inserted into the ODD and control the power supply unit according to the determined type such that the current of the data line is differently controlled.

7. The ODD of claim 6, wherein if, as a result of the determination, the optical disc is determined to be a disc of a video title, the control unit is configured to decrease the current of the data line.

8. The ODD of claim 7, wherein the control unit is configured to control current to be applied to a level falling transition of a signal transmitted via the data line so that the current remains intact and control current to be applied to a level rising transition of the signal so that the current is decreased.

9. The ODD of claim 6, wherein if, as a result of the determination, the optical disc is determined to be an audio disc or a data disc, the control unit is configured to maintain the current of the data line at a preset reference value.

10. The ODD of claim 6, wherein the data line comprises an ATAPI data line.

11. A method of controlling current of a data line, the method comprising:
detecting a pulse cycle and a level transition time in a signal transmitted via a data line coupled to a host;
comparing a reference value and a first value obtained by dividing the level transition time by the pulse cycle; and
maintaining or controlling the current of the data line according to a result of the comparison.

12. The method of claim 11, wherein if, as a result of the comparison, the first value falls within the reference value, current to be applied to a level falling transition and a level rising transition of the signal is maintained at a preset value.

13. The method of claim 11, wherein if, as a result of the comparison, the first value exceeds the reference value, current to be applied to a level falling transition of the signal is maintained at a preset value, and current to be applied to a level rising transition of the signal is increased.

14. The method of claim 11, wherein if, as a result of the comparison, the first value is less than the reference value, current to be applied to a level falling transition of the signal is maintained at a preset value, and current to be applied to a level rising transition of the signal is decreased.

15. The method of claim 11, wherein the data line comprises an ATAPI data line.

16. An apparatus for controlling current of a data line, the apparatus comprising:
an interface unit for connection to a host;
a detection unit configured to detect a pulse cycle and a level transition time in a signal transmitted via the data line coupled to the host;
a power supply unit configured to control the current of the data line; and
a control unit configured to compare a reference value and a first value obtained by dividing the level transition time by the pulse cycle and control the power supply unit to maintain or adjust the current of the data line according to a result of the comparison.

17. The apparatus of claim 16, wherein if, as a result of the comparison, the first value falls within the reference value, the control unit is configured to maintain current to be applied to a level falling transition and a level rising transition of the signal at a preset value.

18. The apparatus of claim 16, wherein if, as a result of the comparison, the first value exceeds the reference value, the control unit is configured to maintain current to be applied to a level falling transition of the signal at a preset value and increase current to be applied to a level rising transition of the signal.

19. The apparatus of claim 16, wherein if, as a result of the comparison, the first value is less than the reference value, the control unit is configured to maintain current to be applied to a level falling transition of the signal at a preset value and decrease current to be applied to a level rising transition of the signal.

20. The apparatus of claim 16, wherein the data line comprises an ATAPI data line.
